(19) United States
(12) Patent Application Publication
(10) Pub. No.: US 2020/0271199 A1
(43) Pub. Date: Aug. 27, 2020

(54) SEALED TENSIONER WITH CLOSED CELL FOAM

(71) Applicant: BorgWarner, Inc., Auburn Hills, MI (US)

(72) Inventor: Adam C. Hunt, Brooktondale, NY (US)

(21) Appl. No.: 16/750,113

(22) Filed: Jan. 23, 2020

Related U.S. Application Data
(60) Provisional application No. 62/808,590, filed on Feb. 21, 2019.

(51) Int. Cl. F16H 7/08

(52) U.S. Cl. CPC F16H 7/0848; F16H 2007/0806; F16H 2007/0859; F16H 2007/0891; F16H 2007/0812

(57) ABSTRACT

A sealed tensioner is used in an automotive application to keep a belt or chain under its intended tension as it wears and stretches. The sealed tensioner is hydraulic but lacks an outside oil supply. The sealed tensioner, in an example, includes a body with a bore. A piston is carried in the bore. A clearance resides at a confrontation between the body and the piston. A check valve is situated between a low pressure reservoir and a high pressure chamber. The sealed tensioner further includes a closed cell foam that is situated at the low pressure reservoir.

### CROSS-REFERENCE TO RELATED PATENT APPLICATIONS

This is a U.S. Non-provisional patent application claiming the benefit of priority from U.S. Provisional patent application No. 62/808,590 filed on Feb. 21, 2019, the entire contents of which are incorporated herein.

### TECHNICAL FIELD

The present application relates generally to tensioners of belt and chain drive configurations in automotive applications and, more particularly, relates to sealed hydraulic tensioners of belt and chain drive configurations in automotive applications that lack an outside oil supply.

### BACKGROUND

Rotations of camshafts and crankshafts of internal combustion engines in automobiles are typically linked together. Belt drive and chain drive configurations are common ways to carry this out. Sprockets on the camshafts and crankshafts are linked by an endless belt in belt drive configurations, and similarly the sprockets are linked by an endless chain in chain drive configurations. Still, other components in automobiles are linked by belt drive and chain drive configurations such as front end accessory drive components.

The belt and chain drive configurations are commonly equipped with tensioners to help keep the belts and chains tight and under the proper tension as they wear and stretch with use. Some tensioners are spring loaded, and some are hydraulically operated. A conventional hydraulically-operated tensioner has an oil supply from an outside source such as the accompanying internal combustion engine. This usually means that the engine and the tensioner have dedicated oil passages communicating with each other. The outside oil supply works an unwanted parasitic loss on the engine, among other potential drawbacks.

### SUMMARY

In one implementation, a sealed tensioner may include a body, a piston, a clearance, a check valve, and a closed cell foam. The body has a bore. The piston is carried in the bore and is biased to an extended state. The clearance resides at a confrontation established between the body and the piston. The check valve is situated between a low pressure reservoir and a high pressure chamber. The closed cell foam is situated at the low pressure reservoir.

In another implementation, a sealed tensioner may include a body, a piston, a clearance, a low pressure reservoir, a high pressure chamber, and a closed cell foam. The piston is carried by the body. The clearance resides between the body and the piston. The lower pressure reservoir contains fluid, and the high pressure chamber contains fluid. The closed cell foam is partially or more exposed to the fluid of the low pressure reservoir. The fluid of the high pressure chamber travels to the low pressure reservoir by way of the clearance when the piston is in the midst of moving to a retracted state. The fluid that travels to the low pressure reservoir compresses the closed cell foam when the piston is in the midst of moving to the retracted state.

In yet another implementation, a sealed tensioner may include a body, a piston, a check valve, a low pressure reservoir, a high pressure chamber, and a closed cell foam. The piston is carried by the body. The piston has a wall. The wall defines an interior of the piston. The wall has an opening. The check valve is located at the piston's interior. The low pressure reservoir is constituted in part or more by the interior of the piston at one side of the check valve. Fluid of the low pressure reservoir can flow through the wall's opening to an exterior of the piston. The high pressure chamber is constituted in part or more by the interior of the piston at another side of the check valve. The closed cell foam is located at the exterior of the piston. The closed cell foam can be compressed in size when the piston is in the midst of moving to a retracted state.

### BRIEF DESCRIPTION OF THE DRAWINGS

FIG. 1 is a sectional view of an embodiment of a sealed tensioner depicted in its extended state;

FIG. 2 is a sectional view of the sealed tensioner of FIG. 1, depicting the sealed tensioner in its retracted state; and

FIG. 2A is an enlarged view of the sealed tensioner taken at the circle denoted by 2A in FIG. 2.

### DETAILED DESCRIPTION

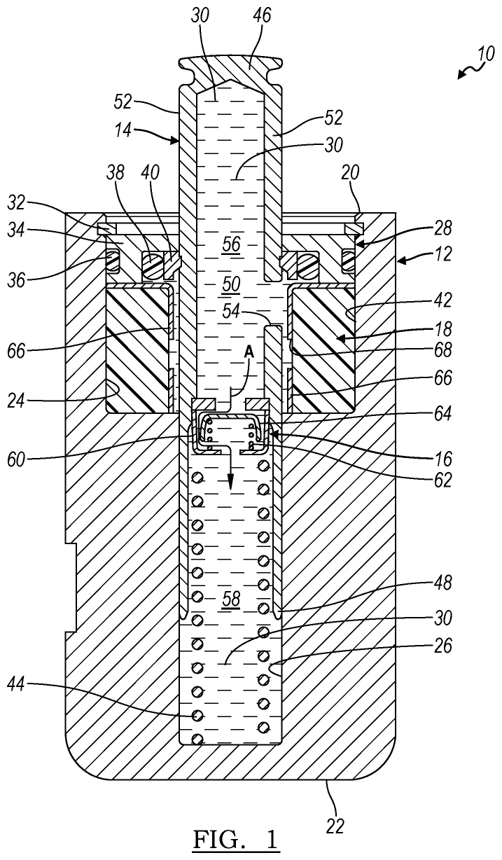

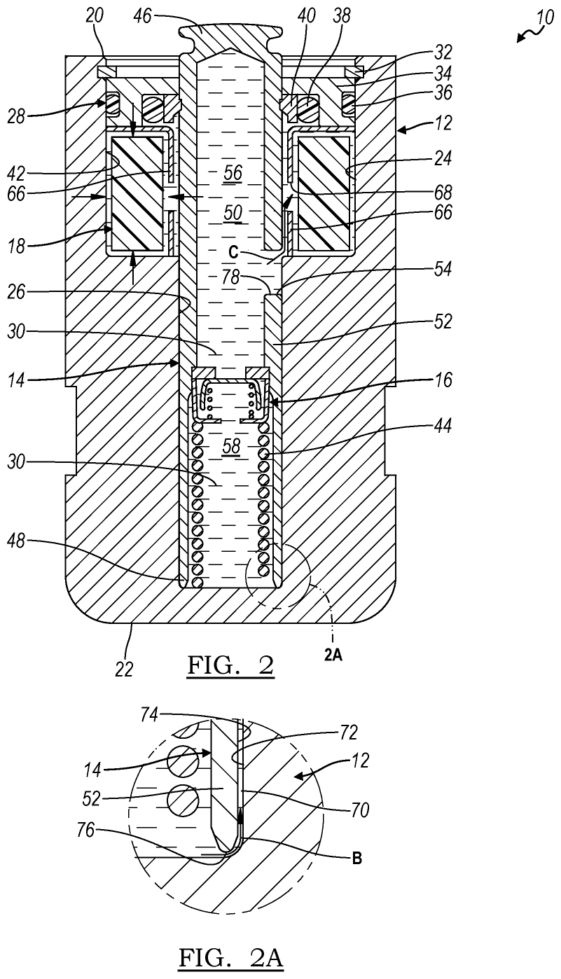

The figures illustrate an embodiment of a sealed tensioner 10 that can be equipped in belt drive and chain drive configurations in automotive applications to help maintain the proper tightness and tension in the associated belts and chains as they wear and stretch with use. The sealed tensioner 10 is hydraulic, and is sealed in the sense that it lacks an outside source of oil supply and hence—unlike some past tensioners—a parasitic loss on the associated larger application is absent with use of the sealed tensioner 10. The outside source of oil supply is commonly from an internal combustion engine in automotive applications. Since the sealed tensioner 10 has no outside oil supply and hence need not be paired with outside oil passages, the sealed tensioner 10 has a greater degree of freedom for its mounting location in the larger application than previously possible. The sealed tensioner 10 can have various designs and constructions in different embodiments, its precise design and construction oftentimes dictated by the particular application in which it will be employed. In the embodiment presented by the figures, and turning now to FIGS. 1 and 2, the sealed tensioner 10 includes a body 12, a piston 14, a check valve 16, and a closed cell foam 18. Still, in other embodiments the sealed tensioner 10 can have more, less, and/or different components than those shown in the figures and described herein.

The body 12 serves as the main structure of the sealed tensioner 10 and supports other components of the sealed tensioner 10. The body 12 itself can be mounted to a larger component like an internal combustion engine, depending on the application. At one end, the body 12 has an open end 20, and at its other end the body 12 has a closed end 22. The body 12 defines a cavity 24 of larger diameter and a bore 26 of smaller diameter. The cavity 24 receives the closed cell foam 18, and the bore 26 receives the piston 14. Furthermore, a seal assembly 28 is held in the body 12 at the cavity 24 and near the open end 20, and seals hydraulic fluid 30 for containment and enclosure within the body 12. The seal assembly 28 in this embodiment includes a retaining ring 32, a seal retainer 34, a first o-ring 36, a second o-ring 38, and a rod seal 40. The retaining ring 32 keeps the seal retainer 34 in place, while the seal retainer 34 keeps the first and second o-rings 36, 38 and the rod seal 40 in place. The first o-ring 36 establishes a seal at a cavity wall 42 of the body 12, and the second o-ring 38 and the rod seal 40 establish seals at the seal retainer 34 and against the piston 14. In other examples of the seal assembly 28, the seal retainer 34 could be press fit in the body 12, and the retaining ring 32 and first o-ring 36 could be absent. Because the sealed tensioner 10 lacks oil supply from an outside source, the body 12 lacks dedicated oil passages for the purpose of connecting to such a supply.

The piston 14 is urged to press against a component of the larger tensioner assembly such as an arm which itself is pressed against the belt or chain of the particular configuration. The piston 14 is slidably carried in the bore 26 and can be reciprocate inward and outward therein in use between an extended state (FIG. 1) and a retracted state (FIG. 2), as well as increments therebetween. The piston 14 is spring loaded and biased toward the extended state by way of a spring 44. At a top end according to the orientation of FIGS. 1 and 2, the piston 14 has a closed end 46, and at an opposite bottom end the piston 14 has an open end 48. The closed end 46 remains projected out of the body 12 for abutment with the arm in installation and use. The piston 14 defines a hollow interior 50 spanning between the closed end 46 and the open end 48 and in which a portion of the fluid 30 is present and contained. A wall 52 of the piston 14 extends between the closed end 46 and the open end 48 and has an opening 54 residing therein and located between the closed and open ends 46, 48. The opening 54 spans completely through the wall 52 so that the interior 50 of the piston 14 can fluidly communicate with an exterior of the piston 14 at the cavity 24. When prompted, the fluid 30 can flow between the interior 50 and the exterior and cavity 24 by way of the opening 54.

The check valve 16 controls flow of the fluid 30 in the sealed tensioner 10 as the piston 14 moves between the extended state and the retracted state, and as the piston 14 moves to incremental states therebetween. The check valve 16 serves as a demarcation and separation between a low pressure reservoir 56 and a high pressure chamber 58 of the sealed tensioner 10. The low pressure reservoir 56 holds the fluid 30 at a lower pressure. The fluid 30 of the low pressure reservoir 56 travels to the high pressure chamber 58 when the piston 14 is in the midst of moving toward the extended state. Conversely, the fluid 30 contained in the high pressure chamber 58 is pressurized to a higher pressure as the piston 14 moves toward the retracted state. The check valve 16 is of the one-way valve type and is spring loaded and biased against fluid-flow from the high pressure chamber 58 to the low pressure reservoir 56. The check valve 16 has a body 60, a spring 62, and a moveable disc 64. The moveable disc 64 is biased to a seated and closed position by the spring 62. The check valve 16 opens to permit flow of the fluid 30 from the low pressure reservoir 56 to the high pressure chamber 58 when the piston 14 moves toward the extended state. The check valve 16, on the other hand, remains closed to prevent flow of the fluid 30 from the high pressure chamber 58 to the low pressure reservoir 56 when the piston 14 moves toward the retracted state.

In the embodiment of FIGS. 1 and 2, the check valve 16 is located within the interior 50 of the piston 14 and is mounted at the inside of the wall 52. The combined construction of the piston 14 and check valve 16 provide a compact design of the sealed tensioner 10 which can more readily satisfy packaging demands in certain applications. In the orientation of the figures, the check valve 16 is positioned at a location that is longitudinally below the opening 54 and longitudinally above the open end 48. By this location, an upper section of the interior 50 of the piston 14 constitutes a section of the low pressure reservoir 56, and a lower section of the interior 50 of the piston 14 constitutes a section of the high pressure chamber 58. Still, in other embodiments the check valve 16 could have different locations and mountings in the sealed tensioner 10; for example, the check valve 16 could be located in the closed end 22 of the body 12 with oil passages defined in the body 12 for a fluid connection between the low pressure reservoir 56 and high pressure chamber 58. And in yet other embodiments the check valve 16 could be a ball check valve or some other type.

The closed cell foam 18 is employed to accommodate and compensate for changes in volume that arise in the sealed tensioner 10 when the piston 14 moves toward its retracted state. In this way, the closed cell foam 18 precludes the occurrence of a hydraulic lock condition in the sealed tensioner 10. The volume of the high pressure chamber 58 decreases as the piston 14 retracts inward in the body 12. The fluid 30 is incompressible and hence cannot itself accommodate the decrease in volume of the high pressure chamber 58. In response, the closed cell foam 18 compresses in size and presents additional volume availability for the fluid 30 in the low pressure reservoir 56. The closed call foam 18 has an expanded state (FIG. 1) when the piston 14 is in the extended state and when no volume compensation is called for in the sealed tensioner 10, and the closed cell foam 18 has a compressed state (FIG. 2) when the piston 14 is in the retracted state and when volume compensation is called for in the sealed tensioner 10. In this embodiment, the closed cell foam 18 is a piece of foam material composed of FKM fluorocarbon; an example of a suitable FKM fluorocarbon is known by the brand name Viton® and is available from The Chemours Company of Wilmington, Del., United States. Still, other materials for the closed cell foam 18 are possible in other embodiments. In the embodiment presented here, the closed cell foam 18 is compressible by way of small pockets of air dispersed throughout the closed cell foam's body. The pockets of air remain encapsulated by the closed cell foam 18 and do not escape to the fluid 30.

In the embodiment of FIGS. 1 and 2, the closed cell foam 18 is located in the cavity 24 of the body 12 and is located at the exterior of the piston 14. The closed cell foam 18 circumferentially surrounds the piston 14. At this location the closed cell foam 18 is situated at the low pressure reservoir 56 and communicates with the fluid 30 of the low pressure reservoir 56. A retainer 66 partially encloses the closed cell foam 18 and keeps it in place. The retainer 66 prevents direct abutment between the closed cell foam 18 and the piston 14. An opening 68 residing in the retainer's wall and spanning therethrough permits flow of the fluid 30 to and from an interior of the retainer 66 where the closed cell foam 18 resides. The retainer 66 can also serve as a support for the seal assembly 28. In other examples not depicted by the figures, the retainer 66 could have a one-piece and unitary construction with the seal retainer 34 of the seal assembly 28.

Turning now to the enlarged view of FIG. 2A, a clearance 70 is incorporated into the design and construction of the body 12 and piston 14 in order to furnish a damping effect therebetween as the fluid 30 is forced to travel therethrough. The clearance 70 serves as a purposefully designed fluid leak path between the body 12 and piston 14. The clearance 70 can have a dimension that ranges approximately between 0.025-0.065 millimeters (mm); still, other values are possible for this dimension. If greater purposeful leakage is desired in the sealed tension 10, for instance, metered flow orifices can be lasered into the disc 64, as but one example for achieving this. The clearance 70 resides at a surface-to-surface confrontation between the body 12 and piston 14, and is defined between an inner surface 72 of the bore 26 and an outer surface 74 of the wall 52. The clearance 70 spans around the entire circumferential extent of confrontation between the body 12 and piston 14. Similarly, the clearance 70 spans the entire longitudinal extent of confrontation between the body 12 and piston 14. With reference to FIGS. 2 and 2A, for instance, on one side of the piston 14 the clearance 70 spans longitudinally from a first end 76 at the piston's open end 48 to a second end 78 at the wall's opening 54.

When the sealed tensioner 10 is put in use and the piston 14 is moving to the extended state, the check valve 16 opens to permit flow of the fluid 30 from the low pressure reservoir 56 to the high pressure chamber 58. An arrowed line A in FIG. 1 demonstrates this permitted fluid flow. Volume in the low pressure reservoir 56 is relieved as a result, and the closed cell foam 18 grows in size to its expanded state. Conversely, and referring now to FIGS. 2 and 2A, when the piston 14 is moving to the retracted state the check valve 16 closes to prevent flow of the fluid 30 from the high pressure chamber 58 to the low pressure reservoir 56 via the check valve 16. The fluid 30 in the high pressure chamber 58 is pressurized and forced to travel through the clearance 70 and to the low pressure reservoir 56. An arrowed line B in FIG. 2A demonstrates this forced fluid flow. The forced fluid flow through the clearance 70 introduces a viscous drag and causes a damping effect on the movement of the piston 14. The movement of the piston 14 is hence inhibited to a degree. The fluid 30 travels through the clearance 70 where it can eventually make its way to the low pressure reservoir 56 and can enter the interior of the retainer 66. An arrowed line C in FIG. 2 demonstrates entrance into the retainer's interior. Volume in the low pressure reservoir 56 is increased as a result, and the closed cell foam 18 shrinks in size to its compressed state.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A sealed tensioner, comprising:
a body having a bore;
a piston carried in the bore and biased to an extended state;
a clearance residing at a confrontation between the body and piston;
a check valve situated between a low pressure reservoir and a high pressure chamber; and
a closed cell foam situated at the low pressure reservoir.

2. The sealed tensioner as set forth in claim 1, wherein the check valve permits fluid-flow from the low pressure reservoir to the high pressure chamber when the piston is in the midst of moving to the extended state.

3. The sealed tensioner as set forth in claim 1, wherein the check valve prevents fluid-flow to the low pressure reservoir from the high pressure chamber when the piston is in the midst of moving to a retracted state.

4. The sealed tensioner as set forth in claim 1, wherein fluid-flow travels from the high pressure chamber to the low pressure reservoir via the clearance when the piston is in the midst of moving to a retracted state.

5. The sealed tensioner as set forth in claim 1, wherein fluid in the low pressure reservoir compresses the closed cell foam when the piston is in the midst of moving to a retracted state.

6. The sealed tensioner as set forth in claim 1, wherein the piston has an interior, the interior constituting a section of the low pressure reservoir, and the check valve mounted within the interior of the piston.

7. The sealed tensioner as set forth in claim 6, wherein the closed cell foam is located at an exterior of the piston, the piston has an opening in a wall thereof, the interior of the piston fluidly communicating with the exterior of the piston via the opening.

8. The sealed tensioner as set forth in claim 1, wherein the body has a cavity, the closed cell foam is located at the cavity, the sealed tensioner further comprises a retainer at least partially enclosing the closed cell foam, the retainer having an opening therein for fluid-flow to and from the closed cell foam.

9. The sealed tensioner as set forth in claim 1, further comprising a seal assembly forming a seal between the body and the piston and enclosing the low pressure reservoir.

10. The sealed tensioner as set forth in claim 1, wherein the sealed tensioner lacks an outside fluid supply.

11. A sealed tensioner, comprising:
a body;
a piston carried by the body;
a clearance residing between the body and the piston;
a low pressure reservoir containing fluid and a high pressure chamber containing fluid; and
a closed cell foam at least partially exposed to the fluid of the low pressure reservoir;
wherein the fluid of the high pressure chamber travels to the low pressure reservoir via the clearance when the piston is in the midst of moving to a retracted state, the fluid traveling to the low pressure reservoir compressing the closed cell foam when the piston is in the midst of moving to the retracted state.

12. The sealed tensioner as set forth in claim 11, further comprising a check valve opening to permit the fluid of the low pressure reservoir to travel to the high pressure chamber when the piston is in the midst of moving to an extended state, and the check valve closing to prevent the fluid of the high pressure chamber from traveling to the low pressure reservoir when the piston is in the midst of moving to the retracted state.

13. The sealed tensioner as set forth in claim 12, wherein the prevention of fluid-flow via the check valve when the piston is in the midst of moving to the retracted state forces the fluid of the high pressure chamber to travel to the low pressure reservoir via the clearance.

14. The sealed tensioner as set forth in claim 13, wherein the fluid of the high pressure chamber being forced to travel to the low pressure reservoir via the clearance damps the movement of the piston to the retracted state.

15. The sealed tensioner as set forth in claim 12, wherein the piston has a wall, the wall defines an interior of the piston with an open bottom end, the wall has an opening therein for flow of the fluid of the low pressure reservoir therethrough, and the check valve is located within the interior of the piston and positioned longitudinally between the open bottom end and the opening in the wall.

16. The sealed tensioner as set forth in claim 15, wherein the closed cell foam is located at an exterior of the piston, the closed cell foam is at least partially enclosed by a retainer, the retainer has an opening therein for fluid-flow to and from the closed cell foam.

17. A sealed tensioner, comprising:
a body;
a piston carried by the body, the piston having a wall defining an interior, the wall having an opening therein;
a check valve located at the interior of the piston;
a low pressure reservoir constituted at least partially by the interior of the piston at one side of the check valve, fluid of the low pressure reservoir flowable through the opening of the wall of the piston to an exterior of the piston;
a high pressure chamber constituted at least partially by the interior of the piston at another side of the check valve; and
a closed cell foam located at the exterior of the piston, the closed cell foam compressible in size when the piston is in the midst of moving to a retracted state.

18. The sealed tensioner as set forth in claim 17, further comprising a clearance residing at a confrontation between the body and the piston, fluid traveling from the high pressure chamber and to the low pressure reservoir via the clearance when the piston is in the midst of moving to the retracted state.

19. The sealed tensioner as set forth in claim 18, wherein the check valve prevents fluid travel from the high pressure chamber to the low pressure reservoir thereat when the piston is in the midst of moving to the retracted state, the prevention of fluid travel at the check valve forcing fluid travel from the high pressure chamber to the low pressure reservoir via the clearance.

20. The sealed tensioner as set forth in claim 19, wherein the clearance spans the entire longitudinal extent of the confrontation between the body and the piston, forced fluid traveling in the clearance damps the movement of the piston to the retracted state.
